(19) United States
(12) Patent Application Publication
(10) Pub. No.: US 2019/0009889 A1
(43) Pub. Date: Jan. 10, 2019

(54) AIRCRAFT

(71) Applicant: Panasonic Intellectual Property Management Co., Ltd., Osaka (JP)

(72) Inventors: Masayuki TOYAMA, Kanagawa (JP); Hideki NAKATA, Kyoto (JP); Hiroyuki MATSUMOTO, Tokyo (JP)

(21) Appl. No.: 16/118,923

(22) Filed: Aug. 31, 2018

Related U.S. Application Data
(63) Continuation of application No. PCT/JP2017/005892, filed on Feb. 17, 2017.

(30) Foreign Application Priority Data
Mar. 10, 2016 (JP) 2016-047278

(51) Int. Cl. B64C 15/02; B64B 1/02; B64C 27/20; G05D 1/08; B64B 1/58; B64C 39/02

(52) U.S. Cl. CPC B64C 15/02; B64B 1/02; B64C 27/20; G05D 1/0808; B64B 1/58; B64C 2201/146; B64C 2201/022; B64C 2201/024; B64C 2201/101; B64C 2201/108; B64C 2201/127; B64C 39/024

(57) ABSTRACT

An aircraft includes: a plurality of rotor units each of which includes a propeller, and a motor which drives the propeller; and a balloon to which the plurality of rotor units are connected and in which a gas less dense than air is contained. At least one rotor unit among the plurality of rotor units generates downward thrust.

### CROSS REFERENCE TO RELATED APPLICATIONS

This application is a U.S. continuation application of PCT International Patent Application Number PCT/JP2017/005892 filed on Feb. 17, 2017, claiming the benefit of priority of Japanese Patent Application Number 2016-047278 filed on Mar. 10, 2016, the entire contents of which are hereby incorporated by reference.

### BACKGROUND

### 1. Technical Field

The present disclosure relates to an aircraft which includes a plurality of rotor units.

### 2. Description of the Related Art

Japanese Unexamined Patent Application Publication No. 2011-046355 discloses an aircraft which includes a plurality of rotor units each including a propeller. This type of aircraft is referred to as a multicopter or a drone, for example.

Japanese Unexamined Patent Application Publication No. H04-022386 discloses an aircraft which includes: a single rotor unit which includes a propeller; and a buoyant body filled with helium gas. The buoyant body of the aircraft disclosed in the publication is donut shaped, and surrounds the single rotor unit.

### SUMMARY

The plurality of rotor units are exposed from the aircraft disclosed in Japanese Unexamined Patent Application Publication No. 2011-046355. The aircraft according to Japanese Unexamined Patent Application Publication No. H04-022386 flies using one rotor unit which includes a large propeller, and thus legs which support the weight of the rotor unit and a fin for controlling a direction of flight project to the outside of the buoyant body. Accordingly, for example, if such an aircraft contacts an object during the flight, the rotor unit and/or the fin, for instance, necessary to fly may be damaged.

Furthermore, according to the aircraft according to Japanese Unexamined Patent Application Publication No. 2011-046355, thrust for causing the aircraft to ascend is generated by only the rotor units, and thus a noise problem and a dead battery problem, for example, readily arise. The aircraft according to Japanese Unexamined Patent Application Publication No. H04-022386 can ascend using the buoyancy of the buoyant body, but nevertheless, for example, a problem that control of orientation is difficult may arise.

The present disclosure has been conceived in view of this point, and provides an aircraft which can readily control movement, rotation, and orientation thereof.

The aircraft according to the present disclosure includes: a plurality of rotor units each of which includes a propeller, and a motor which drives the propeller; and a balloon to which the plurality of rotor units are connected, the balloon containing a gas less dense than air, wherein at least one of the plurality of rotor units generates downward thrust.

According to the aircraft according to the present disclosure, movement, rotation, and orientation can be readily controlled.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a perspective view of an aircraft according to an embodiment obliquely viewed from below;

FIG. 2 is a plan view of the aircraft according to the embodiment;

FIG. 3 is a cross-sectional view of the aircraft illustrating a cross section taken along III-III in FIG. 2;

FIG. 4 is a cross-sectional view of the aircraft illustrating a cross section taken along IV-IV in FIG. 2;

FIG. 5 is a plan view of a balloon according to the embodiment;

FIG. 6 is a cross-sectional view of the balloon illustrating a cross section taken along VI-VI in FIG. 5;

FIG. 7A illustrates an example of operation of a plurality of rotor units when the aircraft ascends;

FIG. 7B illustrates an example of operation of the plurality of rotor units when the aircraft descends;

FIG. 8A illustrates an example of operation of the plurality of rotor units when the aircraft rotates counterclockwise;

FIG. 8B illustrates an example of operation of the plurality of rotor units when the aircraft rotates clockwise;

FIG. 9A illustrates a first example of operation of the plurality of rotor units when the aircraft moves in the horizontal direction;

FIG. 9B is a side view illustrating an orientation when the aircraft moves as illustrated in FIG. 9A;

FIG. 10A illustrates a second example of operation of the plurality of rotor units when the aircraft moves in the horizontal direction;

FIG. 10B is a side view illustrating an orientation when the aircraft moves as illustrated in FIG. 10A;

FIG. 11 illustrates a third example of operation of the plurality of rotor units when the aircraft moves in the horizontal direction;

FIG. 12 is a block diagram illustrating a schematic configuration of the aircraft which includes a detector;

FIG. 13 is a plan view illustrating a schematic configuration of an aircraft which includes five rotor units; and

FIG. 14 illustrates a relation between buoyancy of the aircraft and control of the rotor units.

### DETAILED DESCRIPTION OF THE EMBODIMENTS

The following describes embodiments in detail, with reference to the drawings when necessary. Note that an unnecessarily detailed description may be omitted. For example, a detailed description of a matter already known well and a redundant description of substantially the same configuration may be omitted. This is intended to avoid the following description being unnecessarily redundant, and to facilitate the understanding of those skilled in the art.

Note that the inventors have provided the accompanying drawings and the following description in order to help persons skilled in the art to sufficiently understand the present disclosure, and thus do not intend to limit the disclosed subject matter of the claims by the drawings and the description.

### Embodiment

### [Schematic Configuration of Aircraft]

Aircraft 10 according to an embodiment is to be described.

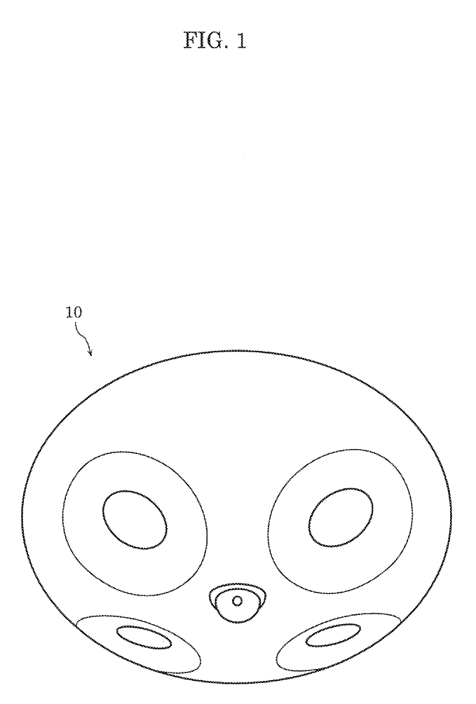

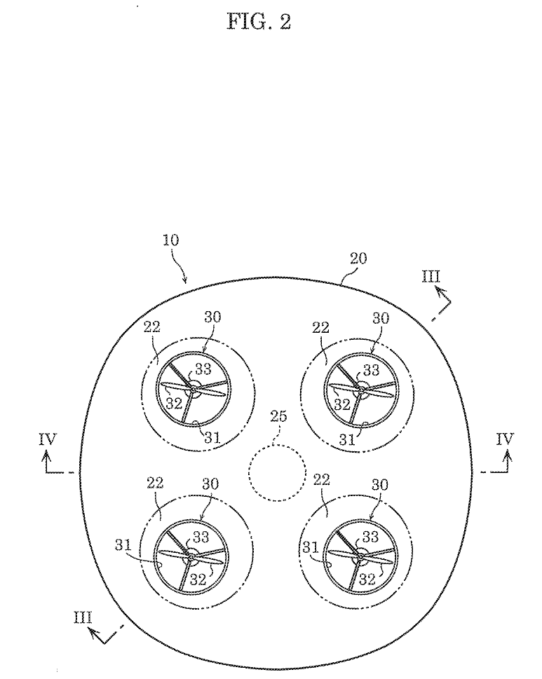

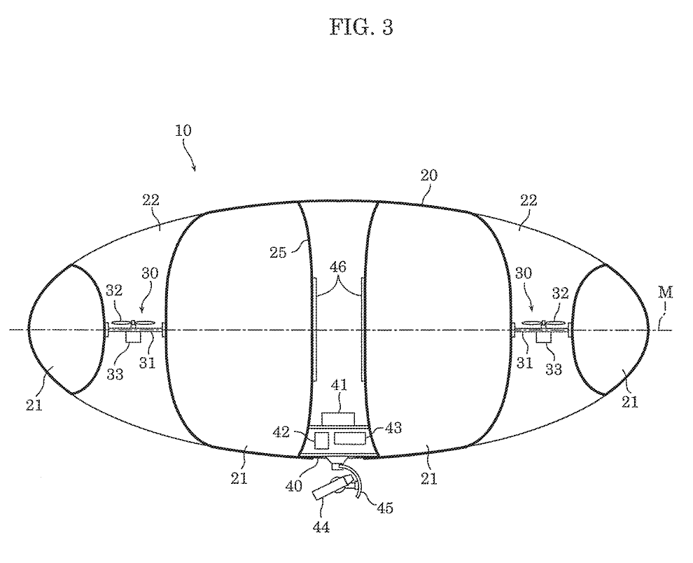

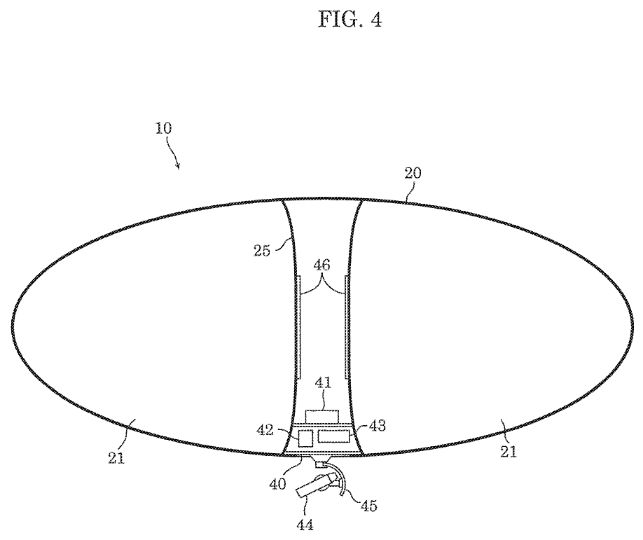

FIG. 1 is a perspective view of the aircraft according to the embodiment obliquely viewed from below. FIG. 2 is a plan view of the aircraft according to the embodiment. FIG. 3 is a cross-sectional view of the aircraft illustrating a cross section taken along III-III in FIG. 2. FIG. 4 is a cross-sectional view of the aircraft illustrating a cross section taken along IV-IV in FIG. 2.

As illustrated in FIGS. 1 and 2, aircraft 10 according to the present embodiment includes balloon 20 as a shock absorber, and four rotor units 30. As illustrated in FIGS. 3 and 4, aircraft 10 includes controller 41, battery 42, projector 43, and camera 44, as mounted devices. Aircraft 10 further includes light emitter 46.

### [Balloon]

Next, balloon 20 is to be described.

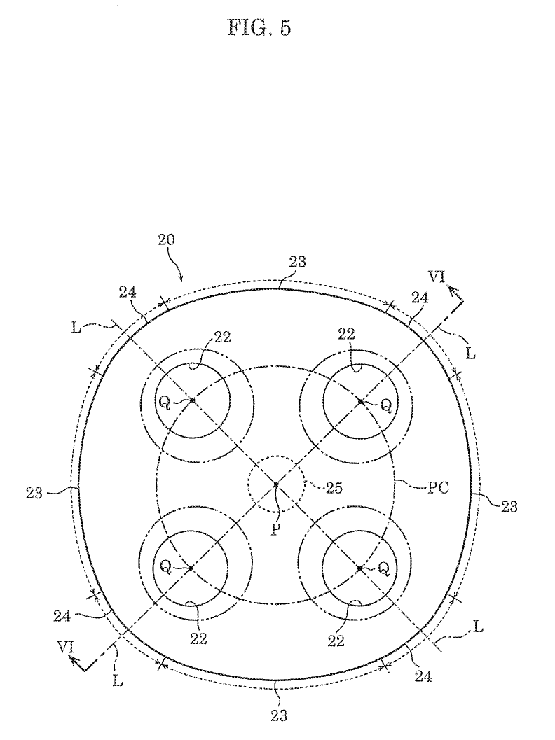

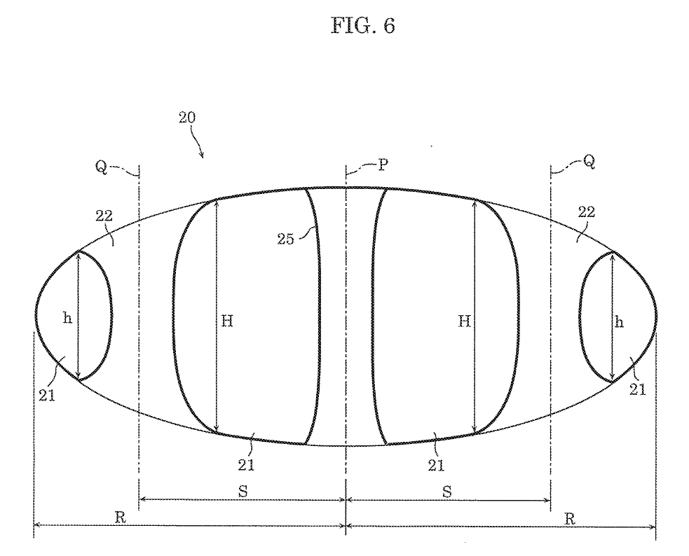

FIG. 5 is a plan view of the balloon according to the embodiment. FIG. 6 is a cross-sectional view of the balloon illustrating a cross section taken along VI-VI in FIG. 5.

As illustrated in FIGS. 3, 4, and 6, balloon 20 is made of a sheet-shaped flexible material (for example, polyvinyl chloride), and has gas space 21 which is a closed space surrounded by the sheet-shaped material. In FIGS. 3, 4, and 6, thick lines show the cross section of the sheet-shaped material of balloon 20. The sheet-shaped material that constitutes the external surface of balloon 20 is a semi-transparent white material which transmits light. A gas which is less dense than air is contained in gas space 21 formed by the sheet-shaped material. In the present embodiment, gaseous helium is contained in balloon 20.

As illustrated in FIG. 5, balloon 20 is formed into a shape rotationally symmetric about a straight line which extends in the up-and-down direction (in the direction perpendicular to the sheet surface of FIG. 5) as an axis of symmetry. The axis of symmetry is central axis P of balloon 20. The shape of balloon 20 illustrated in FIG. 5 has rotational symmetry of 90 degrees. Thus, each time balloon 20 rotates 90 degrees about central axis P, balloon 20 has the same shape as the shape before balloon 20 rotates.

As illustrated in FIG. 6, balloon 20 has a vertically low profile. Balloon 20 has a streamlined shape when laterally viewed. The height of balloon 20 gradually decreases from the central portion of balloon 20 toward the edge portion. Specifically, the cross-sectional shape of balloon 20 passing through central axis P as illustrated in FIG. 6 is an ellipse which has a major axis extending horizontally and a minor axis extending vertically. Thus, the cross-sectional shape of balloon 20 substantially has up and down symmetry. Note that the cross-sectional shape of balloon 20 does not need to be an exact ellipse, and may be a shape that can be recognized as an elliptical shape at a glance.

Ventilation holes 22 as many as rotor units 30 (four ventilation holes 22 in the present embodiment) are formed in balloon 20. As illustrated in FIG. 6, ventilation holes 22 are passages each having an approximately circular cross section, and pass through balloon 20 in the up-and-down direction. Center axes Q of ventilation holes 22 are substantially parallel to central axis P of balloon 20.

As illustrated in FIG. 6, center axes Q of ventilation holes 22 are provided on the edge side of balloon 20 relative to the intermediate position between central axis P and the edge of balloon 20. Specifically, distance S from central axis P of balloon 20 to central axis Q of ventilation hole 22 is longer than one half of distance R from central axis P of balloon 20 to the edge of balloon 20 (S>R/2). Thus, rotor units 30 are disposed in portions of balloon 20 closer to the edge. Such disposition of rotor units 30 is intended to fully secure the spacing between rotor units 30 and stabilize flight of aircraft 10.

The cross-sectional area (the area of a cross section orthogonal to central axis Q) of ventilation hole 22 is the smallest in the center portion in the up-and-down direction. Ventilation hole 22 has a shape having a cross-sectional area which gradually increases from the center portion in the up-and-down direction toward the upper end portion, and also gradually increases from the center portion in the up-and-down direction toward the lower end portion.

Note that the shape of ventilation holes 22 is not limited to this shape, and may be, for example, a tubular shape having a straight center portion in the up-and-down direction. Specifically, ventilation holes 22 have a pillar shape whose center portion in the height direction is narrowed, or a tubular shape having larger cross-sectional areas at an upper end and a lower end.

As described above, balloon 20 has a shape having a height which gradually decreases from the central portion of balloon 20 to the edge portion. Accordingly, height h of each ventilation hole 22 near the edge of balloon 20 is lower than height H near the central portion of balloon 20.

As illustrated in FIG. 5, four ventilation holes 22 are disposed at 90-degree intervals about central axis P of balloon 20. The distance from central axis P of balloon 20 to central axis Q of each ventilation hole 22 is fixed. Specifically, center axes Q of ventilation holes 22 are substantially orthogonal to pitch circle PC about central axis P of balloon 20.

As illustrated in FIG. 5, the edge of balloon 20 in a top view includes reference curve portions 23 and small curvature radius portions 24, the numbers of which are the same as the number of ventilation holes 22 (four each in the present embodiment). Reference curve portion 23 and small curvature radius portion 24 are alternately disposed along the edge of balloon 20 in a top view. Small curvature radius portions 24 are disposed on the outside of ventilation holes 22 (in other words, on a side opposite central axis P of balloon 20), one for each of ventilation holes 22. Reference curve portions 23 are each disposed between two adjacent small curvature radius portions 24.

Reference curve portions 23 and small curvature radius portions 24 are all formed into curved lines. The middle point of each small curvature radius portion 24 in the length direction (circumferential direction) is located on straight line L orthogonal to both central axis P of balloon 20 and central axis Q of ventilation hole 22 closest to small curvature radius portion 24.

The curvature radius of small curvature radius portion 24 is smaller than the curvature radius of reference curve portion 23. Note that the curvature radius of reference curve portion 23 does not need to be constant for the entire length of reference curve portion 23. In addition, the curvature radius of small curvature radius portion 24 does not need to be constant for the entire length of small curvature radius portion 24. When the curvature radii of reference curve portion 23 and small curvature radius portion 24 are not constant, the maximum value of the curvature radius of small curvature radius portion 24 may be smaller than the minimum value of the curvature radius of reference curve portion 23.

Balloon 20 includes tubular connector 25 as illustrated in FIG. 6. Connector 25 is made of a transparent sheet material, and is formed into a cylindrical shape (or a circular tube shape). Connector 25 is disposed in such an orientation that the central axis thereof substantially matches central axis P of balloon 20. In balloon 20, the upper end of connector 25 is joined to the upper portion of balloon 20, and the lower end of connector 25 is joined to the lower portion of balloon 20.

An upper-end surface of tubular connector 25 is closed, whereas the lower-end surface thereof opens. Accordingly, the interior space of connector 25 communicates with the outer space of balloon 20. Air is present in the internal space of connector 25, and the pressure applied in the internal space is substantially the same as an atmospheric pressure.

As described above, balloon 20 is formed into a shape rotationally symmetric about the axis of symmetry which is central axis P extending in the up-and-down direction. Gas such as helium filled in gas space 21 of balloon 20 is uniformly present in the entirety of gas space 21. Accordingly, the point of application of buoyancy (center of buoyancy) exerted by the gas filled in balloon 20 is substantially located on central axis P of balloon 20.

In the present embodiment, the internal volume (that is, the volume of gas space 21) of balloon 20 is set so that the magnitude of buoyancy obtained by the gas filled in balloon 20 is, for example, a value close to the total weight of aircraft 10. Accordingly, even if rotor units 30 have stalled, aircraft 10 can ascend. Alternatively, aircraft 10 can ascend using comparatively small upward thrust generated by rotor units 30.

### [Rotor Unit]

The following describes rotor units 30.

As illustrated in FIGS. 2 and 3, rotor units 30 each include frame 31, propeller 32, and motor 33.

Frame 31 includes a portion formed into a ring shape, and spoke-shaped portions extending from the center toward the ring-shaped portion. Motor 33 is attached to the central portion of frame 31. Propeller 32 is attached to the output shaft of motor 33. The rotation axis of the output shaft of motor 33 (that is, the rotation axis of propeller 32) substantially matches the central axis of frame 31. Note that rotor units 30 may each include two propellers 32 which rotate in opposite directions about the same rotation axis. Specifically, rotor unit 30 may have contra-rotating propellers.

Rotor units 30 are each disposed in a different one of ventilation holes 22. Rotor units 30 are each disposed in such an orientation that the rotation axis of propeller 32 is substantially in the vertical direction. The rotation axis of propeller 32 substantially matches central axis Q of ventilation hole 22. Rotor unit 30 is disposed in a center portion of ventilation hole 22 in the up-and-down direction. Specifically, as illustrated in FIG. 3, rotor unit 30 is disposed so as to overlap center plane M of balloon 20 in the up-and-down direction. Center plane M is located in the center of balloon 20 in the up-and-down direction, and orthogonal to central axis P of balloon 20. The outside diameter of frame 31 of rotor unit 30 is approximately the same as the inside diameter of the center portion of ventilation hole 22 in the up-and-down direction.

Rotor unit 30 is disposed in ventilation hole 22 such that the overall height of rotor unit 30 fits in. Specifically, balloon 20 laterally covers rotor units 30, across the heights of rotor units 30 in the up-and-down direction. Note that the up-and-down direction refers to an up-and-down direction when aircraft 10 is in horizontal orientation and not inclined. Thus, the up-and-down direction is substantially parallel to the rotation axis of rotor unit 30.

Ventilation holes 22 may have a height that is at least the radius of rotor units 30 in both the upward and downward directions from the position of the center of rotor units 30 in the up-and-down direction. Accordingly, even if the rotation axis of propeller 32 of rotor unit 30 is rotated by 90 degrees relative to aircraft 10 due to an impact applied to rotor unit 30 or damage to rotor unit 30, rotor unit 30 can be inhibited from coming out of ventilation hole 22. Accordingly, balloon 20 can laterally cover rotor unit 30 to such an extent that rotor unit 30 cannot readily contact an object.

### [Mounted Device, Light Emitter, and Others]

As described above, aircraft 10 includes controller 41, battery 42, projector 43, and camera 44, as mounted devices. Aircraft 10 further includes light emitter 46.

As illustrated in FIG. 3, disk 40 is disposed in aircraft 10. Disk 40 is a disc-shaped member having a diameter substantially equal to the diameter of the lower end of connector 25, and disposed so as to cover the lower end surface of connector 25. Disk 40 may be made of, for example, a resin material such as polypropylene (PP), polycarbonate (PC), polybutylene terephthalate (PBT), or ABS resin, or metal such as aluminum, copper, or stainless steel.

Camera 44 for capturing images is attached to the bottom surface of disk 40 via gimbal 45. Camera 44 is for capturing images from the sky, and is disposed in an orientation in which camera 44 faces obliquely downward. Gimbal 45 is a member for maintaining the orientation of camera 44 constant, even if the orientation of aircraft 10 changes.

Controller 41, battery 42, and projector 43 are disposed on disk 40. Controller 41 is a device which controls operation of plural rotor units 30. In the present embodiment, controller 41 receives an instruction signal transmitted from a radio remote control, controls rotor units 30, camera 44, projector 43, and LEDs, based on the received instruction signal. Further, controller 41 transmits an image captured by camera 44, for instance.

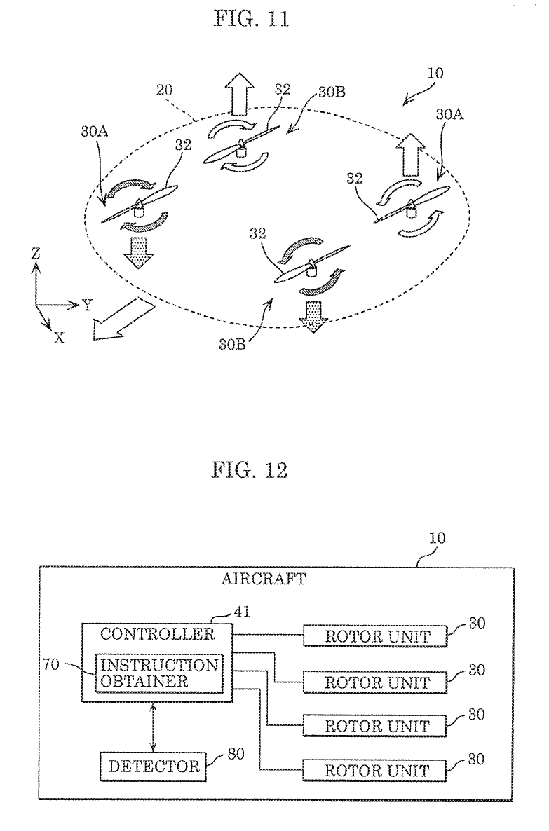

Note that controller 41 includes an instruction obtainer which obtains an instruction signal transmitted from the radio remote control, and operates according to the instruction signal obtained by the instruction obtainer. The instruction obtainer can also obtain a signal output from, for example, a sensor, in addition to an instruction signal transmitted from the radio remote control. The instruction obtainer is later described with reference to FIG. 11.

Note that controller 41 having the above function is achieved by a computer which includes a central processing unit (CPU), random access memory (RAM), read only memory (ROM), a communication interface, and an input/output (I/O) port, for instance.

Controller 41 may include a plurality of controllers having different functions. For example, controller 41 may include a flight controller which controls plural rotor units 30, and a device controller which controls other devices such as camera 44. The controllers may be achieved by different microcontrollers, for example.

Battery 42 supplies power to rotor units 30, controller 41, projector 43, and light emitter 46. Projector 43 projects an image on the inner surface of balloon 20 made of a semi-transparent material.

Light emitter 46 is an LED tape which includes an elongated flexible printed circuit board, and a large number of light emitting elements (LED elements, for example) mounted on the flexible printed circuit board in the longitudinal direction. Light emitter 46 is disposed in the center portion of connector 25 in the up-and-down direction in a tubular form obtained by spirally winding the LED tape with the LED elements facing outward. Specifically, light emitter 46 is disposed so as to cover the inner surface of connector 25. Accordingly, light emitter 46 receives pressure in gas space 21 applied to connector 25, and maintains a predetermined tubular shape of the space inside connector 25. Thus, light emitter 46 restricts, from the inside of connector 25, inward displacement of connector 25 so as to prevent connector 25 from having a smaller space than a predetermined tubular space. As described above, connector 25 is made of a transparent material. Accordingly, light emitted from light emitter 46 transmits connector 25, and hits the inner surface of balloon 20 made of a semi-transparent material.

Note that although light emitter 46 is formed into a tube by spirally winding the LED tape, the present disclosure is not limited thereto, and a member which achieves the tubular shape and the light emitting elements may be separate members. Specifically, the tubular light emitter may be achieved by a combination of a tube-shaped member having a tubular shape and a substrate on which LED elements are mounted.

Aircraft 10 may include only one of projector 43, camera 44, and light emitter 46, or may not include all of them. Furthermore, aircraft 10 may include another type of a device such as a speaker or a display panel. Specifically, aircraft 10 may include devices for achieving a basic flight function, such as rotor units 30, and may include a device which substantially does not affect flight such as projector 43 or camera 44 as appropriate, according to a user's demand, for example.

### [Flying Orientation of Aircraft]

As described above, in aircraft 10, mounted devices such as controller 41 and battery 42 are disposed in the lower end portion of the internal space of connector 25. In other words, mounted devices having a comparatively great weight are disposed in the lower portion of aircraft 10 in a concentrated manner. As a result, the center of gravity of the entirety of aircraft 10 is located below the point of application of buoyancy exerted by a gas filled in balloon 20. Accordingly, even in a state where rotor units 30 have stalled, aircraft 10 maintains such an orientation that camera 44 faces downward, without laterally rotating or being vertically flipped, for instance.

Mounted devices having a comparatively great weight are disposed below rotor units 30. As a result, the center of gravity of the entirety of aircraft 10 is located below the point of application of buoyancy obtained by operation of rotor units 30. Accordingly, while rotor unite 30 are operating, aircraft 10 maintains such an orientation that camera 44 faces downward.

### [Movement of Aircraft and Change of Orientation Thereof]

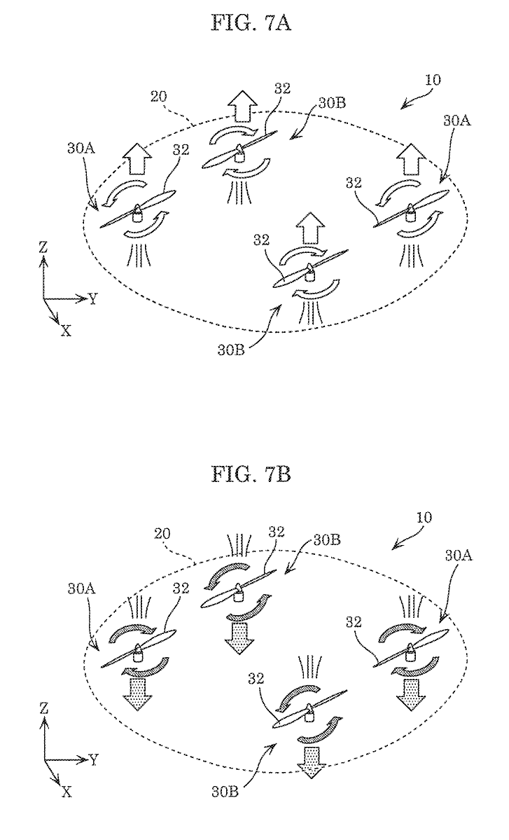

The following describes a specific example of a relation between operation of rotor units 30 and controlling movement and orientation of aircraft 10, with reference to FIGS. 7A to 11.

First, an example of operation of rotor units 30 when aircraft 10 ascends and descends is to be described, with reference to FIGS. 7A and 7B.

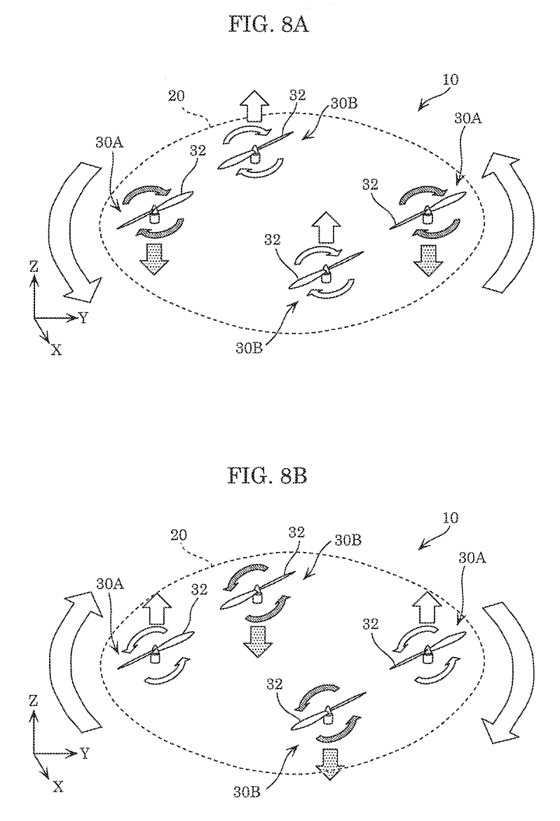

FIG. 7A illustrates an example of operation of rotor units 30 when aircraft 10 ascends, and FIG. 7B illustrates an example of operation of rotor units 30 when aircraft 10 descends. Note that in FIGS. 7A and 7B, the contour of balloon 20 is indicated by the dotted lines in a simplified manner, and illustration of other elements such as camera 44 is omitted, in order to clearly describe operation of rotor units 30. This also applies to FIGS. 8A to 10B and 11 later described.

Aircraft 10 according to the present embodiment includes four rotor units 30 disposed to form a ring shape in a plan view (when viewed from above (the positive side of the Z axis), which also applies to the following). In the present embodiment, rotor units 30 are disposed such that the rotation axes of propellers 32 in rotor units 30 are located on a circular ring centered on center axis P of balloon 20. The rotational directions of propellers 32 for rotor units 30 to generate upward thrust are not the same.

Specifically, in the present embodiment, propellers 32 included in a pair of rotor units 30 located in opposite positions rotate counterclockwise in a plan view, thus generating upward thrust. In FIG. 7A and the diagrams following FIG. 7A, the pair of rotor units 30 are represented by rotor units 30A for convenience, in order to distinguish the rotor units from other rotor units 30.

Among four rotor units 30, a pair of rotor units 30 other than the pair of rotor unite 30A generate upward thrust by propellers 32 rotating clockwise in a plan view. In FIG. 7A and the diagrams following FIG. 7A, the pair of rotor units 30 are represented by rotor units 30B for convenience, in order to distinguish the rotor unite from rotor units 30A. Note that one pair of rotor units among rotor units 30A and rotor units 30B are examples of first rotor units, and the other pair are examples of second rotor units.

Rotation of propellers 32 when rotor units 30 generate upward thrust is expressed as “rotation in a normal direction”, and rotation of propellers 32 when rotor units 30 generate downward thrust is expressed as “rotation in a reverse direction”. For example, when “rotor units 30A rotate in the normal direction”, this means that propellers 32 in rotor units 30A rotate counterclockwise. Furthermore, when “rotor units 30B rotate in the normal direction”, this means that propellers 32 in rotor units 30B rotate clockwise.

In aircraft 10 according to the present embodiment, as illustrated in FIG. 7A, four rotor units 30 (the pair of rotor units 30A and the pair of rotor units 30B) rotate in the normal direction, so that four rotor units 30 produce winds that blow downward. Accordingly, four rotor units 30 generate upward thrust.

Note that association between the rotational direction of rotor units 30 and the direction of thrust is not limited to the above association. For example, rotor units 30A and rotor units 30B include propellers 32 having the identical shape, and thus may generate thrust in the same direction by rotating in the same direction.

For example, rotor units 30 forming a pair and located in opposite positions may each generate thrust in the opposite directions by rotating in the same direction. In other words, one of rotor units 30 forming the pair and located in the opposite positions generates downward thrust by rotating clockwise in a plan view, and the other of rotor units 30 forming the pair and located in the opposite positions generates downward thrust by rotating counterclockwise in a plan view.

Here, in the present embodiment, a gas (gaseous helium in the present embodiment) less dense than air is contained in balloon 20, so that aircraft 10 can rise using only buoyancy of balloon 20 or slight thrust generated by one or more rotor units 30. Accordingly, even if the number of rotations (rotational speed) per unit time of four rotor units 30 is comparatively small, aircraft 10 can ascend quickly. Accordingly, the amount of power in battery 42 consumed can be reduced, for example. Furthermore, a noise problem does not readily arise when aircraft 10 moves upward.

More specifically, as illustrated in FIG. 7A, when each of four rotor units 30 generates upward thrust, propellers 32 in the pair of rotor units 30A rotate counterclockwise, and propellers 32 in the pair of rotor units 30B rotate clockwise. When aircraft 10 is caused to simply ascend, the rotational speeds of four rotor units 30 are approximately the same. In this case, the torque about center axis P of balloon 20 in aircraft 10 is mostly eliminated, and thus the rotation of aircraft 10 about center axis P is inhibited. As a result, energy which rotor units 30 generate is efficiently used for aircraft 10 to ascend.

Note that when aircraft 10 is caused to ascend, for example, the pair of rotor units 30B may be caused to generate upward thrust, and the pair of rotor units 30A may be caused to generate downward thrust. In this case, for example, the buoyancy of balloon 20 can be eliminated by the downward thrust generated by the pair of rotor units 30A. Accordingly, aircraft 10 can be caused to ascend by the upward thrust generated by the pair of rotor units 30B whose rotational speed can be controlled within a comparatively large range.

As illustrated in FIG. 7B, in aircraft 10 according to the present embodiment, four rotor units 30 produce winds that blow upward, by four rotor units 30 rotating in the reverse direction, so as to generate downward thrust. This allows aircraft 10 to smoothly descend, against the buoyancy of balloon 20.

In this case, propellers 32 in the pair of rotor units 30A rotate clockwise, and propellers 32 in the pair of rotor units 30B rotate counterclockwise. When aircraft 10 is caused to simply descend, the rotational speeds of four rotor units 30 are approximately the same. In this case, the torque about center axis P of balloon 20 in aircraft 10 is mostly eliminated, so that rotation of aircraft 10 about center axis P is inhibited. As a result, energy generated by rotor units 30 is efficiently used to cause aircraft 10 to descend.

Note that when aircraft 10 is caused to ascend or when ascending movement of aircraft 10 is accelerated, the number of rotor units 30 caused to rotate in the normal direction may be one or more. When aircraft 10 is caused to descend, the number of rotor units 30 caused to rotate in the reverse direction may be one or more. Specifically, the position of aircraft 10 can be changed upward or downward, using upward thrust or downward thrust generated by at least one rotor unit 30.

Operation of rotor units 30 illustrated in FIGS. 7A and 7B is controlled according to one or more control signals transmitted from controller 41. The control signal which controller 41 transmits to each of rotor units 30 is generated by controller 41, according to an instruction signal transmitted from the radio remote control, for example, as mentioned above. The same also applies to operation of rotor units 30 described with reference to FIGS. 8A to 11 described below.

The following describes an example of operation of rotor units 30 when aircraft 10 rotates, with reference to FIGS. 8A and 8B.

FIG. 8A illustrates an example of operation of rotor units 30 when aircraft 10 rotates counterclockwise, and FIG. 8B illustrates an example of operation of rotor units 30 when aircraft 10 rotates clockwise.

In the example illustrated in FIG. 8A, the pair of rotor units 30A generate downward thrust by rotating in the reverse direction, and the pair of rotor units 30B generate upward thrust by rotating in the normal direction.

In other words, propellers 32 in four rotor units 30 are rotating clockwise. In this case, counterclockwise torque works on aircraft 10 due to the reaction of rotation of propellers 32. As a result, aircraft 10 rotates counterclockwise. The rotation axis at this time is present on the inner side of balloon 20 in a plan view, for example, and ideally matches center axis P of balloon 20. Specifically, aircraft 10 can rotate counterclockwise, substantially without changing the position thereof in a plan view.

Furthermore, in the present embodiment, the pair of rotor units 30A generate downward thrust, and the pair of rotor units 30B generate upward thrust. Accordingly, the downward thrust generated by the pair of rotor units 30A and the upward thrust generated by the pair of rotor units 30B are offset by each other. As a result, aircraft 10 can rotate counterclockwise, while being inhibited from moving in the up-and-down direction.

In other words, balloon 20 has buoyancy, and thus the pair of rotor units 30A can be caused to rotate in the reverse direction (rotate clockwise) so as to generate counterclockwise torque. This allows aircraft 10 to quickly rotate counterclockwise, and inhibits aircraft 10 from moving in the up-and-down direction.

Thus, aircraft 10 according to the present embodiment can rotate counterclockwise on the spot, upon receipt of, for example, an instruction signal indicating counterclockwise rotation from the radio remote control.

Here, assume the case where aircraft 10 does not include balloon 20, or the case where a gas less dense than air, such as gaseous helium, is not contained in balloon 20. In this case, for example, the pair of rotor units 30B are caused to rotate in the normal direction (clockwise) at high speed, and the pair of rotor units 30B are caused to rotate in the normal direction (counterclockwise) at low speed, whereby aircraft 10 can be caused to rotate counterclockwise while hovering. However, in this case, clockwise torque is generated by the pair of rotor units 30B, which impedes quick counterclockwise rotation of aircraft 10. In this regard, aircraft 10 according to the embodiment includes balloon 20 having buoyancy, and thus all rotor units 30 can be caused to rotate clockwise (some of rotor units 30 can be caused to generate downward thrust). Accordingly, aircraft 10 can be caused to quickly rotate counterclockwise while hovering.

Furthermore, the same applies to the case where aircraft 10 is caused to rotate clockwise while hovering, and upward thrust is generated by rotating the pair of rotor units 30A in the normal direction and downward thrust is generated by rotating the pair of rotor units 30B in the reverse direction, as illustrated in FIG. 8B. Specifically, four rotor units 30 each rotate counterclockwise.

Accordingly, clockwise torque is generated in aircraft 10, and furthermore, the upward thrust generated by the pair of rotor units 30A and the downward thrust generated by the pair of rotor units 30B are offset by each other. As a result, aircraft 10 which includes balloon 20 having buoyancy can rotate clockwise, while being inhibited from moving in the up-and-down direction.

In this manner, according to aircraft 10 according to the present embodiment, orientation can be readily controlled (aircraft 10 rotates in FIGS. 8A and 8B).

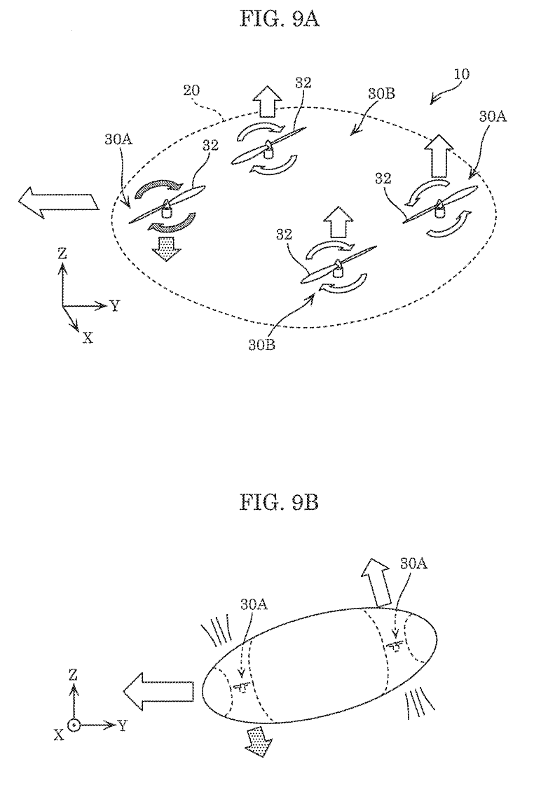

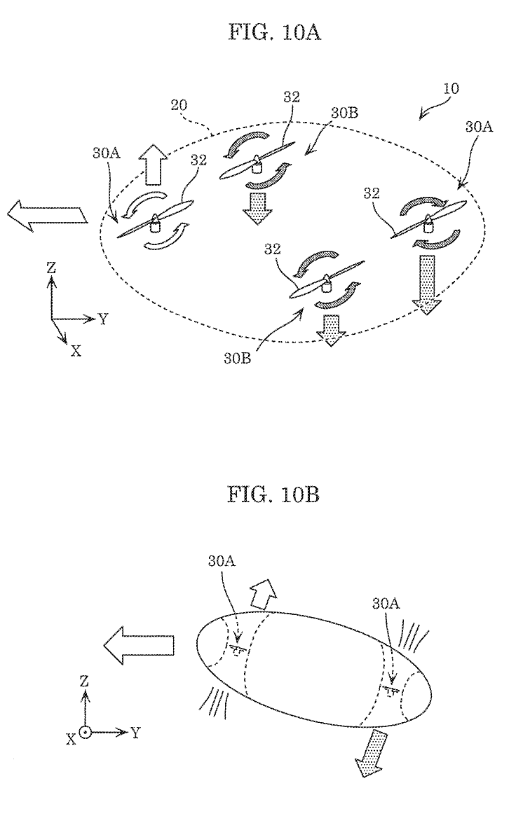

The following describes an example of operation of rotor units 30 when aircraft 10 moves in the direction crossing the up-and-down direction (horizontal direction), with reference to FIGS. 9A to 10B.

FIG. 9A illustrates a first example of operation of rotor units 30 when aircraft 10 moves in the horizontal direction, and FIG. 9B is a side view illustrating orientation of aircraft 10 when aircraft 10 moves as illustrated in FIG. 9A.

In the example illustrated in FIG. 9A, among the pair of rotor units 30A disposed in the lateral direction (Y axial direction), rotor unit 30A on the left generates downward thrust by rotating in the reverse direction, and rotor unit 30A on the right generates upward thrust by rotating in the normal direction. For example, the thrust generated by rotor unit 30A on the right is greater than the thrust generated by rotor unit 30A on the left. As a result, as illustrated in FIG. 9B, aircraft 10 is inclined such that the left side is lower and the right side is higher, and moves leftward.

In this case, the pair of rotor units 30B in the X axial direction each generate upward thrust by rotating in the normal direction, and aircraft 10 is inclined as illustrated in FIG. 9B, so that a portion of thrust generated by rotor units 30B is used as thrust for aircraft 10 to move leftward.

Note that in this case, rotor unit 30A on the right rotating in the normal direction (counterclockwise) is controlled such that the rotational speed thereof is higher than the rotational speed of rotor unit 30A on the left rotating in the reverse direction (clockwise). Accordingly, the pair of rotor units 30A generate clockwise torque. However, the clockwise torque can be eliminated by counterclockwise torque generated by the pair of rotor units 30B which both rotate in the normal direction (clockwise). Thus, aircraft 10 can be moved while inhibiting rotation of aircraft 10 about center axis P of balloon 20.

Here, in the case of this example, a resultant force of thrust generated by four rotor units 30 and buoyancy of balloon 20 has upward components. However, aircraft 10 proceeds in an orientation in which aircraft 10 tilts downward in a travel direction, and thus flies while receiving downward force due to air resistance. Accordingly, aircraft 10 can be moved in a substantially horizontal direction. For example, aircraft 10 can be moved obliquely upward by increasing the rotational speed of rotor unit 30A on the right which generates upward thrust.

For example, aircraft 10 can be moved in the horizontal direction by causing rotor units 30 to operate as illustrated in FIG. 10A.

FIG. 10A illustrates a second example of operation of rotor units 30 when aircraft 10 moves in the horizontal direction. FIG. 10B is a side view illustrating an orientation when aircraft 10 moves as illustrated in FIG. 10A.

In the example illustrated in FIG. 10A, among the pair of rotor units 30A disposed in the Y axial direction, rotor unit 30A on the right generates downward thrust by rotating in the reverse direction, and rotor unit 30A on the left generates upward thrust by rotating in the normal direction. The thrust generated by rotor unit 30A on the right is greater than the thrust generated by rotor unit 30A on the left. As a result, as illustrated in FIG. 10B, aircraft 10 moves leftward in a state in which aircraft 10 is inclined such that the left side is higher and the right side is lower.

In this case, the pair of rotor units 30B disposed in the X axial direction each generate downward thrust by rotating in the reverse direction, and since aircraft 10 is inclined as illustrated in FIG. 10B, a portion of thrust generated by rotor units 30B is used as thrust for aircraft 10 to move leftward.

Note that in this case, a resultant force of thrust generated by four rotor units 30 has downward components. However, aircraft 10 proceeds in an orientation in which aircraft 10 tilts upward in a travel direction, and thus flies while receiving upward force due to air resistance. Accordingly, the resultant force of the upward force and the buoyancy of balloon 20 allows aircraft 10 to maintain a floating state. In this case, aircraft 10 can be moved in a substantially horizontal direction. Aircraft 10 can be moved obliquely downward by, for example, increasing the rotational speed of rotor unit 30A on the right which generates downward thrust.

In the case of this example, rotor unit 30A on the right rotating in the reverse direction (clockwise) is controlled so that the rotational speed thereof is higher than the rotational speed of rotor unit 30A on the left rotating in the normal direction (counterclockwise). Accordingly, the pair of rotor units 30A produce counterclockwise torque. However, the counterclockwise torque can be eliminated by clockwise torque generated by the pair of rotor units 30B both rotating in the reverse direction (counterclockwise). Specifically, aircraft 10 can be moved while inhibiting rotation of aircraft 10 about center axis P of balloon 20.

FIGS. 9A to 10B illustrate the case where aircraft 10 moves leftward (in the negative direction of the Y axis), and a description thereof has been given. However, in FIGS. 9A to 10B, for example, if rotation in the normal direction and rotation in the reverse direction of rotor units 30A forming a pair are switched, aircraft 10 moves rightward (in the positive direction of the Y axis). Accordingly, illustration and description of operation of rotor units 30 when aircraft 10 moves rightward are omitted.

In aircraft 10 according to the present embodiment, a pair of rotor unit 30A and rotor unit 30B are caused to generate upward thrust, and remaining rotor unit 30A and rotor unit 30B may be caused to generate downward thrust. Such control allows aircraft 10 to move in the horizontal direction.

FIG. 11 illustrates a third example of operation of rotor units 30 when aircraft 10 moves in the horizontal direction.

In the example illustrated in FIG. 11, rotor unit 30A and rotor unit 30B that are located on the far side both rotate in the normal direction, thus generating downward thrust, and rotor unit 30A and rotor unit 30B that are located on the near side both rotate in the reverse direction, thus generating downward thrust. Accordingly, aircraft 10 is inclined such that the side where rotor unit 30A and rotor unit 30B which generate downward thrust are disposed is lower, and moves in the horizontal direction.

Thus, in aircraft 10 according to the present embodiment, the position of aircraft 10 in a plan view is changed by propeller 32 which is included in at least one rotor unit 30 rotating in the reverse direction, and propeller 32 which is included in at least one different rotor unit 30 rotating in the normal direction.

Note that operations of aircraft 10 described with reference to FIGS. 7A to 11 are examples, and various orientation controls and various movement controls can be performed according to a combination of normal rotation and reverse rotation of rotor units 30 and the rotational speeds of propellers 32 in rotor units 30.

As described above, since aircraft 10 according to the present embodiment includes balloon 20 having buoyancy, for example, thrust for causing aircraft 10 to rise can be provided by balloon 20. Accordingly, aircraft 10 can be caused to efficiently move upward. Furthermore, one or more rotor units 30 are caused to rotate in the reverse direction if necessary, whereby at least a portion of the buoyancy of balloon 20 can be eliminated. Accordingly, the range for controlling the rotational speeds of rotor units 30 can be increased, and as a result, movement and orientation can be readily controlled.

### [Control Based on Result of Detection by Sensor]

In the present embodiment, it is assumed that aircraft 10 operates according to an instruction signal transmitted from the radio remote control. However, aircraft 10 may operate according to the result of detection by the detector included in aircraft 10, instead of or in addition to the instruction signal transmitted from the radio remote control.

FIG. 12 is a block diagram illustrating a schematic configuration of aircraft 10 which includes detector 80.

Aircraft 10 illustrated in FIG. 12 includes detector 80 which detects the state of aircraft 10. Detector 80 includes an acceleration sensor, for example. Controller 41 included in aircraft 10 includes instruction obtainer 70. Instruction obtainer 70 obtains an instruction signal from the radio remote control, and a signal output by detector 80, for example. Note that FIG. 12 omits illustration of other elements such as battery 42.

When aircraft 10 is caused to fly outdoors, for example, aircraft 10 may abruptly ascend due to a gust blowing. In this case, detector 80 detects the state where aircraft 10 is abruptly ascending, and outputs a predetermined signal which indicates that state. Instruction obtainer 70 receives the predetermined signal. In this case, controller 41 rotates at least one of rotor units 30 in the reverse direction, for example. Alternatively, controller 41 increases the rotational speed of one or more rotor units 30 rotating in the reverse direction at the time. As a result, downward thrust which works on aircraft 10 is increased, and ascending movement of aircraft 10 is inhibited. Specifically, instruction obtainer 70 obtains an instruction according to the result of detection by detector 80, and controller 41 causes at least one rotor unit 30 to generate downward thrust according to the instruction.

Note that controller 41 may perform control for inhibiting ascending movement of aircraft 10 when it is determined that abrupt ascending movement of aircraft 10 is not a normal operation, based on, for instance, the rotational speeds of rotor units 30 at the time. For example, detector 80 obtains information on, for instance, the rotational speeds of rotor units 30 at the time, and if it is determined, based on the obtained information, that abrupt ascending movement of aircraft 10 is not a normal operation, detector 80 may output a predetermined signal. Accordingly, for example, if such abrupt ascending movement of aircraft 10 is a normal operation based on an instruction signal from the radio remote control, the operation is prevented from being impeded.

Detector 80 may output a predetermined signal which includes information on an inclination direction, for instance, if the inclination relative to the horizontal plane of aircraft 10 detected by detector 80 is greater than or equal to a predetermined value. In this case, when instruction obtainer 70 receives the predetermined signal, controller 41 causes one or more rotor units 30 disposed at a portion which has moved upward when viewed from center axis P of balloon 20 to rotate in the reverse direction. Accordingly, one or more rotor units 30 generate downward thrust, and as a result, inclination of aircraft 10 is inhibited.

Note that when it is determined that inclination of aircraft 10 is not a normal operation, based on, for instance, the rotational speeds of rotor units 30 at the time, controller 41 may perform control for inhibiting inclination of aircraft 10. For example, detector 80 obtains information on, for instance, the rotational speeds of rotor units 30 at the time, and when it is determined that inclination of aircraft 10 is not a normal operation, detector 80 may output a predetermined signal. Accordingly, for example, if the inclination of aircraft 10 is a normal operation based on an instruction signal from the radio remote control, the operation is prevented from being impeded.

Detector 80 may detect the state (such as abrupt movement) of aircraft 10 using imaging data captured by camera 44 included in aircraft 10. In this case, camera 44 may have the function of detector 80. Specifically, camera 44 may function as detector 80.

As described above, aircraft 10 includes detector 80 which detects the state of aircraft 10, and thus when an unexpected change occurs in the position or orientation of aircraft 10 due to a gust or contact with an obstacle, a change in the position or orientation of aircraft 10 can be automatically inhibited.

### [Advantageous Effects and Others]

Aircraft 10 according to the present embodiment includes rotor units 30 each of which includes propeller 32, and motor 33 which drives propeller 32, and balloon 20 to which rotor units 30 are connected. A gas less dense than air is contained in balloon 20, and at least one rotor unit 30 among rotor units 30 generates downward thrust.

According to this configuration, aircraft 10 flies using both buoyancy obtained by the gas filled in balloon 20 and buoyancy obtained by air currents generated by rotor unit(s) 30 (upward thrust). Accordingly, as compared to the case where when aircraft 10 flies using only the buoyancy obtained by operation of rotor unit 30, consumption of energy such as power which is to be used for driving rotor units 30 can be kept low. Accordingly, the time of flight of aircraft 10 can be extended, for example.

Here, aircraft 10 has a feature that aircraft 10 readily moves using comparatively small thrust, since balloon 20 has buoyancy. On the other hand, if all rotor units 30 generate only upward thrust, the rotational speeds of rotor units 30 are to be controlled within a comparatively narrow range.

However, in aircraft 10 according to the present embodiment, at least one rotor unit 30 generates downward thrust. Accordingly, at least one rotor unit 30 can be caused to generate downward thrust at arbitrary timing so as to eliminate at least a portion of the buoyancy of balloon 20. Accordingly, the control range of the rotational speeds of one or more different rotor units 30 is increased, and as a result, the position, rotation, or orientation of aircraft 10 is readily controlled.

Specifically, aircraft 10 according to the present embodiment can fly efficiently using the buoyancy of balloon 20, and causes one or more rotor units 30 to generate downward thrust when necessary, whereby the position, rotation, or orientation thereof can be readily controlled.

In the present embodiment, balloon 20 laterally covers rotor units 30, across a height of rotor units 30 in an up-and-down direction.

According to the configuration, when aircraft 10 contacts an object during the flight, not rotor units 30 but balloon 20 contacts the object. Specifically, even if aircraft 10 contacts an object during the flight, aircraft 10 can avoid contact of rotor units 30 with the object. Thus, according to the present embodiment, even if aircraft 10 contacts an object during the flight, damage to rotor units 30 due to the contact can be prevented, so that aircraft 10 can be allowed to continue stable flight.

If aircraft 10 falls, balloon 20 filled with a gas hits, for instance, the ground, and consequently deforms, which reduces the impact. Thus, according to the present embodiment, damage to rotor units 30 due to the fall can be prevented. Even if aircraft 10 falls, balloon 20 contacts an object, rather than rotor units 30 or mounted devices, which can reduce damage to the object due to contact with aircraft 10.

In the present embodiment, balloon 20 includes plural ventilation holes 22 which pass through balloon 20 in an up-and-down direction, and plural rotor units 30 are each disposed in a different one of plural ventilation holes 22.

Accordingly, for example, this reduces a possibility that wind blowing from each rotor unit 30 is disturbed by wind blowing from other rotor units 30. Furthermore, for example, this reduces a possibility that rotor units 30 interfere each other even if the shape of balloon 20 is distorted due to collision with an obstacle, for instance.

More specifically, in balloon 20, a space filled with gas such as helium is formed not only in a region which surrounds the entirety of rotor units 30 disposed in predetermined positions, but also in regions between rotor units 30. Thus, according to the present embodiment, the internal volume of balloon 20 can be secured, and an increase in the size of balloon 20 can be prevented.

In aircraft 10 which includes plural rotor units 30, the spacing between rotor units 30 may be increased to some extent, in order to allow aircraft 10 to stably fly. On the other hand, as described above, in balloon 20 according to the present embodiment, gas space 21 filled with gas such as helium is present also in regions between plural rotor units 30. Thus, according to the present embodiment, the amount of gas filled can be secured while inhibiting an increase in the size of aircraft 10, and furthermore, the spacing between rotor units 30 can be secured. Accordingly, the flight state of aircraft 10 can be stabilized.

In the present embodiment, each of rotor units 30 generates upward thrust by propeller 32 rotating in the normal direction, and generates downward thrust by propeller 32 rotating in the reverse direction.

Each of rotor units 30 can switch the direction of generated thrust from one of upward and downward to the other, by rotating propeller 32 in the normal direction or the reverse direction. Accordingly, for example, the flexibility of the control of movement and orientation of aircraft 10 is high.

Aircraft 10 according to the present embodiment includes controller 41 which controls operation of rotor units 30. Controller 41 moves or rotates aircraft 10 in a plan view by causing propeller 32 in at least one rotor unit 30 among rotor units 30 to rotate in the reverse direction.

According to this configuration, aircraft 10 can execute controlling operation of rotor units 30. Accordingly, for example, the position or orientation of aircraft 10 can be changed by merely transmitting, from the radio remote control to controller 41, an instruction signal which indicates, for instance, a direction in which aircraft 10 is to move.

In the present embodiment, rotor units 30 are disposed to form a ring shape in the plan view. Further, a position of aircraft 10 in the plan view is changed by propeller 32 in at least one rotor unit 30 rotating in the reverse direction and propeller 32 in, among plural rotor units 30, at least one rotor unit 30 different from at least one rotor unit 30 rotating in the normal direction.

Specifically, aircraft 10 can be inclined by causing one or more rotor units 30 to generate downward thrust and causing one or more rotor units 30 to generate upward thrust, while eliminating the buoyancy of balloon 20. Accordingly, a portion of the upward thrust or the downward thrust which one or more rotor units 30 generate can be used as thrust for movement in the horizontal direction, and as a result, aircraft 10 can be stably moved in the horizontal direction.

In the present embodiment, plural rotor units 30 are disposed to form a ring shape in the plan view, and include: a pair of rotor units 30A which are located in opposite positions, and a pair of rotor units 30B which are located in opposite positions. Rotor units 30A generate downward thrust by propellers 32 rotating clockwise, and rotor units 30B generate downward thrust by propellers 32 rotating counterclockwise. In this configuration, when the pair of rotor units 30A generate downward thrust and the pair of rotor units 30B generate upward thrust, the pair of rotor units 30A rotate clockwise, and the pair of rotor units 30B also rotate clockwise.

Specifically, the rotational directions of propellers 32 in a total of four rotor units 30 are all clockwise, and aircraft 10 rotates counterclockwise in a plan view due to counterclockwise torque generated by the clockwise rotation. A resultant force of thrust generated by four rotor units 30 can be brought to zero or a value close to zero in the up-and-down direction. Accordingly, aircraft 10 can be rotated while inhibiting movement of aircraft 10.

In the present embodiment, aircraft 10 descends by all rotor units 30 generating downward thrust. In this case, for example, aircraft 10 which includes balloon 20 having buoyancy can be landed quickly.

In the present embodiment, aircraft 10 includes instruction obtainer 70 which obtains an instruction for causing at least one rotor unit 30 to generate downward thrust. When instruction obtainer 70 obtains the instruction, at least one rotor unit 30 generates downward thrust. Note that an example of an instruction for causing at least one rotor unit 30 to generate downward thrust is an instruction for moving aircraft 10 or changing orientation thereof, the instruction being for causing one or more rotor units 30 to generate downward thrust and causing one or more different rotor units 30 to generate upward thrust.

Accordingly, aircraft 10 can be caused to operate, for example, to move or rotate at a timing which a user desires, for example.

In the present embodiment, aircraft 10 includes detector 80 which detects a state of aircraft 10. Instruction obtainer 70 obtains an instruction according to a result of detection by detector 80.

According to this configuration, controller 41 can cause at least one rotor unit 30 to generate downward thrust, based on a result of detection by detector 80. Accordingly, for example, when an abnormality such as abrupt ascending movement of aircraft 10 or an inclination of aircraft 10 greater than or equal to a reference value occurs, aircraft 10 can be caused to operate so as to automatically overcome such an abnormal state.

### Other Embodiments

The above has described the embodiments as examples of technology disclosed in the present application. However, technology according to the present disclosure is not limited to this, and is also applicable to embodiments on which change, replacement, addition, and omission, for instance, is appropriately performed.

For example, in the above embodiments, the number of rotor units 30 included in aircraft 10 is 4, yet the number of rotor units 30 included in aircraft 10 is not limited to 4. The aircraft may include a plurality of rotor units, and at least one of the plurality of rotor units may be able to generate downward thrust. In addition, the balloon may include a plurality of ventilation holes in each of which one of the rotor units is disposed. For example, if the aircraft includes N rotor units (N is an integer greater than or equal to 2), the balloon may have N or more ventilation holes.

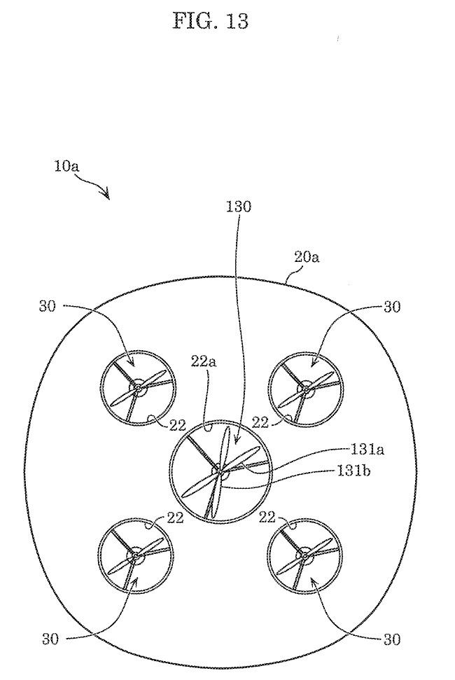

FIG. 13 is a plan view illustrating a schematic configuration of aircraft 10a which includes five rotor units.

Aircraft 10a illustrated in FIG. 13 includes balloon 20a in which a gas less dense than air is contained, and four rotor units 30 disposed to form a ring shape in a plan view. Four rotor units 30 are disposed in ventilation holes 22 which balloon 20 has. This structure is common to aircraft 10a and aircraft 10 according to the above embodiment.

However, aircraft 10a further includes rotor unit 130 in a position surrounded by four rotor units 30, and rotor unit 130 is disposed in ventilation hole 22a provided in a center portion of balloon 20.

Rotor unit 130 includes two propellers (propellers 131a and 131b) that rotate in opposite directions about the same rotation axis. In other words, rotor unit 130 includes contra-rotating propellers. Accordingly, rotor unit 130 does not substantially generate torque that rotates aircraft 10a, even if propellers 131a and 131b are caused to rotate in order to generate thrust. Accordingly, in aircraft 10a, similarly to aircraft 10 according to the above embodiment, four rotor units 30 are controlled so as to eliminate torque generated by each of four rotor units 30, whereby rotation of aircraft 10a (rotation of balloon 20a about the center axis in a plan view) can be inhibited.

Accordingly, since rotor unit 130 which does not influence rotation of aircraft 10a is included, rotor unit 130 can also be caused to operate only to generate downward thrust, for example.

Specifically, rotor unit 130 can be used, only in order to eliminate the buoyancy of balloon 20a and cause aircraft 10a to descend against the buoyancy of balloon 20. Accordingly, for example, the buoyancy of balloon 20a can be readily eliminated by adjusting at least one of the type, amount, and density of a gas contained in balloon 20a, even if balloon 20a is given comparatively high buoyancy. As a result, for example, the position, rotation, or orientation of aircraft 10a can be readily controlled by controlling operation of four rotor units 30.

Of course, the direction of thrust generated by rotor unit 130 may be switchable from one of upward and downward to the other. In this case, for example, this allows aircraft 10a to ascend at high speed.

Note that in aircraft 10a, elements other than rotor units 30 and 130, such as controller 41 and battery 42, are disposed in a well balanced manner in a housing portion (not illustrated) provided in balloon 20a. Accordingly, the center of gravity of aircraft 10a can be brought to or brought close to the center axis of balloon 20a in a plan view.

In the above embodiment, the direction of thrust generated by all rotor units 30 included in aircraft 10 can be switched from one of upward and downward to the other. However, for example, two of four rotor units 30 included in aircraft 10 may generate only upward thrust, and two remaining rotor units 30 may generate only downward thrust. As stated in the above description about aircraft 10a, when one rotor unit generates only downward thrust, one or more remaining rotor units may generate only upward thrust. In either case, at least one rotor unit generates downward thrust, thus facilitating controlling at least one of movement, rotation, and orientation of an aircraft which includes a balloon having buoyancy.

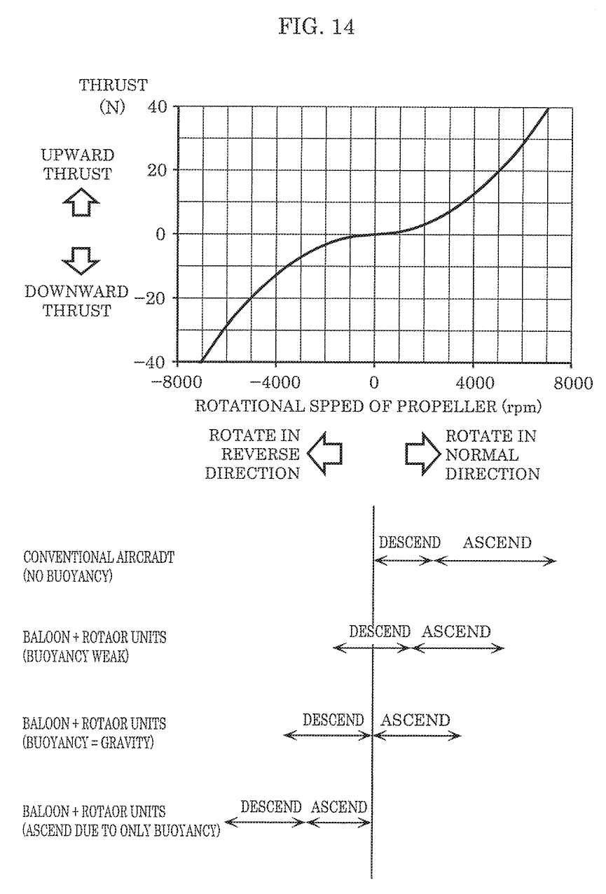

Here, facilitating control of an aircraft which includes a balloon having buoyancy is now described with reference to FIG. 14.

FIG. 14 illustrates a relation between the buoyancy of an aircraft and control of rotor units.

The graph in the upper part of FIG. 14 illustrates an example of a relation between the number of rotations of propellers in rotor units and generated thrust. Under the graph in FIG. 14, a rough relation between the magnitude of buoyancy of an aircraft and a control range of the number of rotations when the aircraft ascends and descends is illustrated.

Note that FIG. 14 and a description thereof illustrate control of four rotor units included in the aircraft when the aircraft is caused to ascend and descend by the rotor units performing the same operation, in order to clarify what is described. The horizontal axis of the graph in FIG. 14 represents the rotational speed of the rotor units, and the vertical axis represents a total value of thrust generated by the four rotor units.

As is clear from the graph illustrated in FIG. 14, the higher the rotational speed (absolute value) of propellers is, the more abruptly thrust generated by rotor units changes.

On the assumption, in the case of a conventional aircraft which does not include a balloon having buoyancy, the rotor units are controlled in a range having a lower limit of 2000 rpm or more, for example, in which the rotational speed is comparatively high, when the aircraft ascends. Specifically, the rotational speed of the rotor units is controlled in a range in the graph in FIG. 14, in which an inclination is great. Accordingly, for example, when the aircraft ascends, a small change in the rotational speed may greatly change thrust generated by the rotor units. When the aircraft descends, the gravity exerted on the aircraft works as downward thrust as it is, and thus the rotor units are controlled so that the rotational speed is low, yet the control range is narrow. Accordingly, for example, when the aircraft is to be caused to descend at a desired velocity, it is difficult to adjust the velocity.

On the other hand, in an aircraft which includes a balloon having buoyancy like aircraft 10 according to the present embodiment, the rotor units when the aircraft ascends are controlled in a range of lower rotational speeds, as compared with the rotor units in the conventional aircraft.

For example, as illustrated in FIG. 14, if the buoyancy exerted by the balloon is equal to the gravity which works on the aircraft (in other words, the weight of the aircraft), when the aircraft ascends, the rotational speed of the rotor units is controlled in a range from about 0 rpm to about 3000 rpm, for example. Specifically, the rotational speed of the rotor units is controlled in a range in the graph in FIG. 14 in which an inclination is small. Accordingly, it is easier to adjust thrust when the aircraft ascends, as compared with the conventional aircraft.

When the aircraft descends, the rotor units are controlled in a range from about −3000 rpm to about 0 rpm, for example. Specifically, the control range of the rotational speed of the rotor units when the aircraft descends is wider, as compared with the conventional aircraft. Accordingly, for example, when the aircraft is caused to descend at a desired velocity, it is easy to adjust the velocity to the desired velocity.

Note that even if the buoyancy exerted by the balloon is weak (in the case of “buoyancy weak” in FIG. 14), the range of the rotational speed of the rotor units when the aircraft ascends is a range of lower rotational speeds as illustrated in FIG. 14, as compared with the conventional aircraft. Accordingly, it is easier to adjust thrust when the aircraft ascends than the conventional aircraft. Accordingly, for example, even if the buoyancy exerted by balloon 20 included in aircraft 10 according to the above embodiment is less than the weight of aircraft 10, control of aircraft 10 is facilitated.

When the buoyancy exerted by the balloon is greater than the weight of the aircraft (in the case of “ascend due to only buoyancy” in FIG. 14), the aircraft can be caused to ascend without thrust generated by the rotor units, for example. In this case, for example, as illustrated in FIG. 14, when the aircraft ascends, the rotor units are caused to generate downward thrust by rotating the propellers in the reverse direction, so that the ascending velocity can be controlled. Note that even if the buoyancy exerted by the balloon is greater than the weight of the aircraft, the rotor units may be caused to generate upward thrust when the aircraft ascends, in order to cause the aircraft to ascend at higher speed, for example.

Here, in aircraft 10 according to the above embodiment, among plural rotor units 30, one or more rotor units different from at least one rotor unit 30 can generate upward thrust while at least one rotor unit 30 is generating downward thrust. In aircraft 10 having such a configuration, one or more rotor units 30 generating upward thrust and at least one rotor unit 30 generating downward thrust may be controlled in a range of a rotational speed in which a change in thrust relative to a change in the rotational speed is small.

Accordingly, for example, even if the number of rotations of rotor units 30 greatly changes, a change in thrust is inhibited, and thus the control of movement of aircraft 10, for instance, is facilitated.

Balloon 20 included in aircraft 10 may cause aircraft 10 to rise using only buoyancy of balloon 20. Accordingly, for example, this allows aircraft 10 to ascend at higher speed, and to descend (land) using one or more rotor units 30 generating downward thrust.

For example, movable flaps may be provided at lower end portions of ventilation holes 22, in order to change the direction of wind blowing from rotor units 30. Accordingly, for example, if aircraft 10 rotates in a plan view due to torque generated by rotor units 30, the direction of wind blowing from rotor units 30 (the direction of thrust) can be adjusted in order to inhibit the rotation. Controlling inclination of one or more flaps enables operation such as movement or rotation of aircraft 10.

In the present embodiment, the upper end of connector 25 is closed, but may be open to the outside. Accordingly, the upper end and the lower end of the space inside connector 25 are open to the outside, and thus a gas in the space inside connector 25 can be readily caused to flow. Accordingly, a mounted device disposed in the space inside connector 25 can be efficiently cooled. Note that in this case, if a configuration is adopted in which a gas is caused to further readily flow by providing a plurality of through holes or notches in disk 40, a gas in the space inside connector 25 can be caused to more readily flow, and thus a mounted device can be more effectively cooled.

For example, in aircraft 10 according to the above embodiment, rotor units 30 may be each removable from balloon 20. Accordingly, for example, when aircraft 10 is carried, rotor units 30 can be removed from balloon 20, and balloon 20 can be folded up small. As a result, the size of packed aircraft 10 when carried can be reduced.

Ventilation holes 22 the number of which is greater than the number of rotor units 30 may be formed in balloon 20. In this case, there is at least one ventilation hole 22 in which rotor unit 30 is not disposed. If such ventilation hole 22 in which rotor unit 30 is not disposed is provided in balloon 20, when aircraft 10 ascends and descends, air resistance which works on aircraft 10 can be reduced.

A protection net which overlies ventilation hole 22 of balloon 20 may be provided for each ventilation hole 22. In this case, protection nets are disposed for each ventilation hole 22 above and below rotor unit 30. The protection nets prevent, for example, foreign matters from entering ventilation holes 22, and accordingly, this reduces a possibility that propellers 32 in rotor units 30 contact foreign matters.

Note that the aircraft which includes the protection nets may have a configuration in which the ventilation holes included in the aircraft have a height which does not allow the protection nets to touch the rotor units even if the balloon and a protection net deform due to contact with an object. Accordingly, even if an object contacts a protection net, the object is inhibited from contacting a rotor unit.

As described above, the embodiments are described as an example of technology according to the present disclosure. The accompanying drawings and a detailed description are provided therefor.

Thus, the elements illustrated in the accompanying drawings and described in the detailed description may include not only elements necessary for addressing the problem, but also elements not necessarily required for addressing the problem, in order to illustrate the above technology. Accordingly, a fact that such unnecessarily required elements are illustrated in the accompanying drawings and described in the detailed description should not immediately lead to a determination that such unnecessarily required elements are required.

In addition, the embodiments described above are intended to illustrate the technology according to the present disclosure, and thus various changes, replacement, addition, and omission, for instance, can be performed within the scope of claims and equivalent thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful for an aircraft which includes a plurality of rotor units and a balloon.

What is claimed is:

1. An aircraft, comprising:
a plurality of rotor units each of which includes a propeller, and a motor which drives the propeller;
a balloon to which the plurality of rotor units are connected, the balloon containing a gas less dense than air; and
a controller which controls operation of the plurality of rotor units, wherein
each of the plurality of rotor units generates upward thrust by the propeller rotating in a normal direction, and generates downward thrust by the propeller rotating in a reverse direction, and
the controller causes the aircraft to rotate in a plan view or move, by causing the propeller included in at least one rotor unit among the plurality of rotor units to rotate in the reverse direction.

2. The aircraft according to claim 1, wherein
the plurality of rotor units are disposed to form a ring shape in the plan view, and
a position of the aircraft in the plan view is changed by the propeller in the at least one rotor unit rotating in the reverse direction and the propeller in, among the plurality of rotor units, at least one rotor unit different from the at least one rotor unit rotating in the normal direction.

3. The aircraft according to claim 1, wherein
the plurality of rotor units are disposed to form a ring shape in the plan view, and include:
a pair of first rotor units which are located in opposite positions, and generate downward thrust by the propellers rotating clockwise in the plan view; and
a pair of second rotor units which are located in opposite positions, and generate downward thrust by the propellers rotating counterclockwise in the plan view, and
the aircraft is caused to rotate counterclockwise in the plan view by the pair of first rotor units generating downward thrust and the pair of second rotor units generating upward thrust.

4. The aircraft according to claim 1, wherein
the aircraft is caused to descend by all the plurality of rotor units generating downward thrust.

5. The aircraft according to claim 1, further comprising:
an instruction obtainer which obtains an instruction for causing the at least one rotor unit to generate downward thrust, wherein
when the instruction obtainer obtains the instruction, the at least one rotor unit generates downward thrust.

6. The aircraft according to claim 5, further comprising:
a detector which detects a state of the aircraft, wherein
the instruction obtainer obtains an instruction according to a result of detection by the detector.

7. The aircraft according to claim 1, wherein
among the plurality of rotor units, one or more rotor units different from the at least one rotor unit generate upward thrust while the at least one rotor unit is generating downward thrust, and
the one or more rotor units generating upward thrust and the at least one rotor unit generating downward thrust are controlled in a range of a rotational speed in which a change in thrust relative to a change in the rotational speed is small.

8. The aircraft according to claim 1, wherein
the balloon causes the aircraft to rise using only buoyancy of the balloon.

9. The aircraft according to claim 1, wherein
the balloon laterally covers the plurality of rotor units, across a height of the plurality of rotor units in an up-and-down direction.

10. The aircraft according to claim 1, wherein
the balloon includes a plurality of ventilation holes which pass through the balloon in an up-and-down direction, and
the plurality of rotor units are each disposed in a different one of the plurality of ventilation holes.
